(19) United States
(12) Patent Application Publication
(10) Pub. No.: US 2017/0221235 A1
(43) Pub. Date: Aug. 3, 2017

(54) NEGATIVE DICTIONARY LEARNING

(71) Applicant: General Electric Company, Schenectady, NY (US)

(72) Inventors: Bruno Kristiaan Bernard De Man, Clifton Park, NY (US); Lin Fu, Niskayuna, NY (US); Jiajia Luo, Schenectady, NY (US); Eri Haneda, Clifton Park, NY (US); Sathish Ramani, Schenectady, NY (US)

(21) Appl. No.: 15/012,556

(22) Filed: Feb. 1, 2016

(51) Int. Cl. G06T 11/00; G06T 5/00; G06K 9/62

(52) U.S. Cl. CPC G06T 11/008; G06K 9/6255; G06T 5/002; G06T 2211/424; G06T 2207/20081; G06T 2207/10081

(57) ABSTRACT

The present approach relates to the use of a database (i.e., a dictionary) of image patterns to be avoided or de-emphasized during an image reconstruction process, such as an iterative image reconstruction process. Such a dictionary may be characterized as a negative or “bad” dictionary. The negative dictionary may be used to constrain an image reconstruction process to avoid or minimize the presence of the patterns present in the negative dictionary.

### STATEMENT REGARDING FEDERALLY SPONSORED RESEARCH & DEVELOPMENT

This invention was made with Government support under contract number HSHQDC-14-C-B0048 awarded by the Department of Homeland Security. The Government has certain rights in the invention.

### BACKGROUND

The subject matter disclosed herein relates to tomographic reconstruction, and in particular to the use of dictionary learning algorithms.

Non-invasive imaging technologies allow images of the internal structures or features of a patient/object to be obtained without performing an invasive procedure on the patient/object. In particular, such non-invasive imaging technologies rely on various physical principles (such as the differential transmission of X-rays through the target volume, the reflection of acoustic waves within the volume, the paramagnetic properties of different tissues and materials within the volume, the breakdown of targeted radionuclides within the body, and so forth) to acquire data and to construct images or otherwise represent the observed internal features of the patient/object.

All reconstruction algorithms suffer from reconstruction artifacts such as streaks and noise. To reduce these artifacts, regularization based methods have been introduced. However, there are often trade-offs between computational-efficiency, dose, scanning speed, and image quality. Therefore, there is a need for improved reconstruction techniques, particularly in the low-signal-to-noise ratio (SNR) imaging context.

### BRIEF DESCRIPTION

Certain embodiments commensurate in scope with the originally claimed subject matter are summarized below. These embodiments are not intended to limit the scope of the claimed subject matter, but rather these embodiments are intended only to provide a brief summary of possible embodiments. Indeed, the invention may encompass a variety of forms that may be similar to or different from the embodiments set forth below.

In one implementation, a method of constructing a negative dictionary is provided. In accordance with this method, one or more images are accessed. A plurality of image patches are sampled from the one or more images. A subset of the image patches corresponding to detrimental image features or patterns are identified. The negative dictionary is populated using the subset of image patches.

In a further implementation, a reconstruction method is provided. In accordance with this method, a set of measurements are acquired for an imaged volume. A reconstruction of the set of measurements is performed using a negative dictionary. The negative dictionary comprises image patches corresponding to detrimental image features or patterns that are actively suppressed or negatively weighted during the reconstruction. A reconstructed image is generated as an output of the reconstruction.

In another implementation, an image processing system is provided. In accordance with this implementation, the image processing system includes a memory storing one or more routines and a processing component configured to access previously or concurrently acquired measurement data and to execute the one or more routines stored in the memory. The one or more routines, when executed by the processing component: perform a reconstruction of a set of measurements using a negative dictionary, wherein the negative dictionary comprises image patches corresponding to detrimental image features or patterns that are actively suppressed or negatively weighted during the reconstruction; and generate a reconstructed image as an output of the reconstruction.

### BRIEF DESCRIPTION OF THE DRAWINGS

These and other features, aspects, and advantages of the present invention will become better understood when the following detailed description is read with reference to the accompanying drawings in which like characters represent like parts throughout the drawings, wherein:

FIG. 1 is a block diagram depicting components of a computed tomography (CT) imaging system, in accordance with aspect of the present disclosure;

FIG. 2 depicts an example of a dictionary for use in a dictionary learning approach, in accordance with aspect of the present disclosure;

FIG. 3 depicts a process flow for a sparse coding process by which sparse representation coefficients are estimated, in accordance with aspect of the present disclosure;

FIG. 4 depicts a dictionary training process flow, in accordance with aspect of the present disclosure;

FIG. 5 depicts a prior art process flow of a dictionary learning image reconstruction approach;

FIG. 6 depicts a process flow of a dictionary learning image reconstruction approach using a negative dictionary, in accordance with aspect of the present disclosure;

FIG. 7 depicts an example of an initial phantom image;

FIG. 8 depicts the image of FIG. 7 after addition of noise, artifacts, and blurring; and

FIG. 9 depicts the image of FIG. 8 after image processing using a dictionary learning approach based on a negative dictionary, in accordance with aspect of the present disclosure.

### DETAILED DESCRIPTION

One or more specific embodiments will be described below. In an effort to provide a concise description of these embodiments, not all features of an actual implementation are described in the specification. It should be appreciated that in the development of any such actual implementation, as in any engineering or design project, numerous implementation-specific decisions must be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure

While aspects of the following discussion are provided in the context of medical imaging, it should be appreciated that the present techniques are not limited to such medical contexts. Indeed, the provision of examples and explanations in such a medical context is only to facilitate explanation by providing instances of real-world implementations and applications. However, the present approaches may also be utilized in other contexts, such as the non-destructive inspection of manufactured parts or goods (i.e., quality control or quality review applications), and/or the non-invasive inspection of packages, boxes, luggage, and so forth (i.e., security or screening applications). In general, the present approaches may be desirable in any imaging or screening context in which high-resolution image processing, including but not limited to image reconstruction, is desirable.

Further, though CT examples are provided primarily by way of example, it should be understood that the present approach may be used in other imaging modality contexts. For instance, the presently described approach is also suitable for use with other types of tomographic scanners including, but not limited to, positron emission tomography (PET), single photon emission computed tomography (SPECT), and magnetic resonance imaging (MRI), or to image restoration or denoising in general.

One image reconstruction technique used in CT imaging is iterative reconstruction. Use of iterative reconstruction techniques (in contrast to analytical methods) may be desirable for a variety of reasons. Iterative reconstruction algorithms can offer advantages in terms of modeling (and compensating for) the physics of the scan acquisition, modeling the statistics of the measurements to improve the image quality and incorporating prior information. For example, such iterative reconstruction methods may be based on discrete imaging models and may realistically model the system optics, scan geometry, and noise statistics. Prior information may be incorporated into the iterative reconstruction using Markov random field neighborhood regularization, Gausssian mixture priors, dictionary learning techniques, and so forth.

As a result, iterative reconstruction techniques thus often achieve superior image quality, though at relatively high computational cost. For example, model-based iterative reconstruction (MBIR) is a reconstruction technique which iteratively estimates the spatial distribution and values of attenuation coefficients of an image volume from measurements. MBIR is based on an optimization problem whereby a reconstructed image volume is calculated by solving an objective function containing both data fitting and regularizer terms which in combination control the trade-off between data fidelity and image quality. The data fitting (i.e., data fidelity) term minimizes the error between reconstructed result and the acquired data according to an accurate model that takes the noise into consideration. The regularizer term takes the prior knowledge of the image (e.g., attenuation coefficients that are similar within a small neighborhood) to reduce possible artifacts, such as streaks and noise. Therefore, MBIR is tolerant to noise and performs well even in low dose situation.

Recently, dictionary learning (DL) approaches have been applied as a regularizer for low-dose CT reconstruction due to the ability of this approach to keep local structures and reduce noise. For example, in the image prior term of the reconstruction function, a dictionary learning formula may be employed instead of a conventional function based on pairwise neighboring interaction. Thus, in such a scenario, the reconstruction function will have a data fidelity term and a dictionary learning-based prior modeling term.

As discussed herein, a particular dictionary learning based approach is described. This approach, referred to as “negative” dictionary learning herein, helps improve the use of prior information, such as to be more specific, by adding a constraint to actively suppress (e.g., negatively weight or penalize) certain dictionary patterns. That is, a “negative” dictionary of patterns that are of no interest or actually detrimental to image quality is employed. Though reconstruction techniques are described herein by way of example, it should be appreciated that the present negative or subtractive dictionary learning approaches may be used more generally in other image processing contexts, not merely reconstruction. That is, the present approaches may be used in any image processing context where use of dictionary learning as part of the processing (e.g., as an image or term regularizer, as a data fit term, or as a cost function component) is suitable. Similarly though three-dimensional (3D) or volumetric imaging is primarily described herein to provide suitable context and examples, the present approaches are equally applicable in image processing or reconstruction in other dimensional contexts. For instance, the present approaches may be suitable for use in two-dimensional contexts and four-dimensional (i.e., 3D over time) contexts as well as the three-dimensional context provided as examples.

With the preceding introductory comments in mind, the approaches described herein may be suitable for use with a range of image processing or reconstruction systems that employ dictionary learning as part of the executed algorithms. To facilitate explanation, the present disclosure will primarily discuss the present approaches in one particular context, that of a CT system. However, it should be understood that the following discussion may also be applicable to other image modalities and systems as well as to non-medical contexts or any context where dictionary learning is suitable for use in an image processing or reconstruction context.

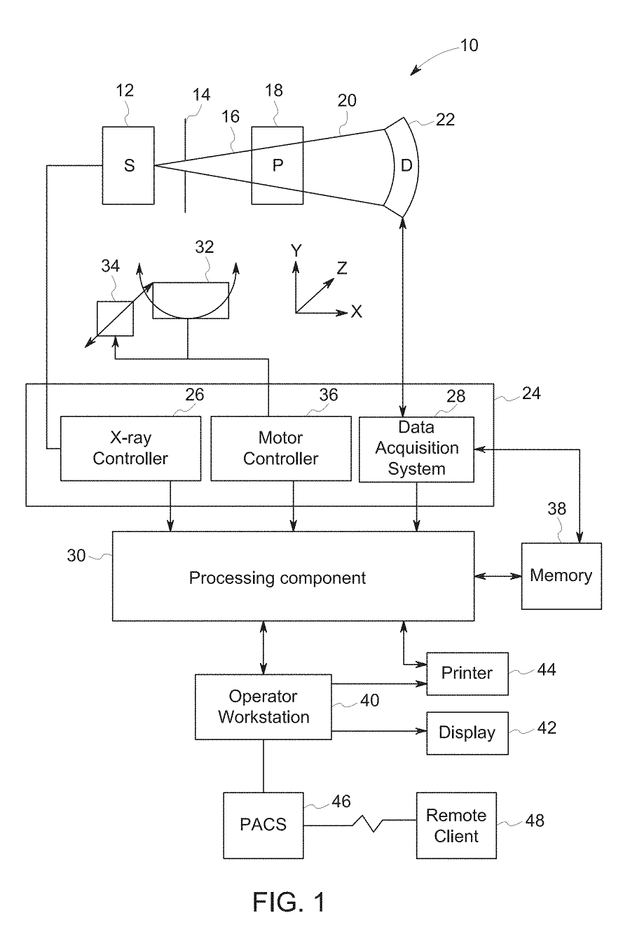

With this in mind, an example of a computer tomography (CT) imaging system 10 designed to acquire X-ray attenuation data at a variety of views around a patient (or other subject or object of interest) and suitable for performing image reconstruction using MBIR techniques is provided in FIG. 1. In the embodiment illustrated in FIG. 1, imaging system 10 includes a source of X-ray radiation 12 positioned adjacent to a collimator 14. The X-ray source 12 may be an X-ray tube, a distributed X-ray source (such as a solid-state or thermionic X-ray source) or any other source of X-ray radiation suitable for the acquisition of medical or other images.

The collimator 14 shapes or limits a beam of X-rays 16 that passes into a region in which a patient/object 18, is positioned. In the depicted example, the X-rays 16 are collimated to be a cone-shaped beam, i.e., a cone-beam, that passes through the imaged volume. A portion of the X-ray radiation 20 passes through or around the patient/object 18 (or other subject of interest) and impacts a detector array, represented generally at reference numeral 22. Detector elements of the array produce electrical signals that represent the intensity of the incident X-rays 20. These signals are acquired and processed to reconstruct images of the features within the patient/object 18.

Source 12 is controlled by a system controller 24, which furnishes both power, and control signals for CT examination sequences, including acquisition of two-dimensional localizer or scout images used to identify anatomy of interest within the patient/object for subsequent scan protocols. In the depicted embodiment, the system controller 24 controls the source 12 via an X-ray controller 26 which may be a component of the system controller 24. In such an embodiment, the X-ray controller 26 may be configured to provide power and timing signals to the X-ray source 12.

Moreover, the detector 22 is coupled to the system controller 24, which controls acquisition of the signals generated in the detector 22. In the depicted embodiment, the system controller 24 acquires the signals generated by the detector using a data acquisition system 28. The data acquisition system 28 receives data collected by readout electronics of the detector 22. The data acquisition system 28 may receive sampled analog signals from the detector 22 and convert the data to digital signals for subsequent processing by a processor 30 discussed below. Alternatively, in other embodiments the digital-to-analog conversion may be performed by circuitry provided on the detector 22 itself. The system controller 24 may also execute various signal processing and filtration functions with regard to the acquired image signals, such as for initial adjustment of dynamic ranges, interleaving of digital image data, and so forth.

In the embodiment illustrated in FIG. 1, system controller 24 is coupled to a rotational subsystem 32 and a linear positioning subsystem 34. The rotational subsystem 32 enables the X-ray source 12, collimator 14 and the detector 22 to be rotated one or multiple turns around the patient/object 18, such as rotated primarily in an x,y-plane about the patient. It should be noted that the rotational subsystem 32 might include a gantry upon which the respective X-ray emission and detection components are disposed. Thus, in such an embodiment, the system controller 24 may be utilized to operate the gantry.

The linear positioning subsystem 34 may enable the patient/object 18, or more specifically a table supporting the patient, to be displaced within the bore of the CT system 10, such as in the z-direction relative to rotation of the gantry. Thus, the table may be linearly moved (in a continuous or step-wise fashion) within the gantry to generate images of particular areas of the patient 18. In the depicted embodiment, the system controller 24 controls the movement of the rotational subsystem 32 and/or the linear positioning subsystem 34 via a motor controller 36.

In general, system controller 24 commands operation of the imaging system 10 (such as via the operation of the source 12, detector 22, and positioning systems described above) to execute examination protocols and to process acquired data. For example, the system controller 24, via the systems and controllers noted above, may rotate a gantry supporting the source 12 and detector 22 about a subject of interest so that X-ray attenuation data may be obtained at one or more views relative to the subject. In the present context, system controller 24 may also include signal processing circuitry, associated memory circuitry for storing programs and routines executed by the computer (such as routines for executing image processing techniques described herein), as well as configuration parameters, image data, and so forth.

In the depicted embodiment, the image signals acquired and processed by the system controller 24 are provided to a processing component 30 for reconstruction of images in accordance with the presently disclosed algorithms. The processing component 30 may be one or more general or application-specific microprocessors. The data collected by the data acquisition system 28 may be transmitted to the processing component 30 directly or after storage in a memory 38. Any type of memory suitable for storing data might be utilized by such an exemplary system 10. For example, the memory 38 may include one or more optical, magnetic, and/or solid state memory storage structures. Moreover, the memory 38 may be located at the acquisition system site and/or may include remote storage devices for storing data, processing parameters, and/or routines for image reconstruction, as described below.

The processing component 30 may be configured to receive commands and scanning parameters from an operator via an operator workstation 40, typically equipped with a keyboard and/or other input devices. An operator may control the system 10 via the operator workstation 40. Thus, the operator may observe the reconstructed images and/or otherwise operate the system 10 using the operator workstation 40. For example, a display 42 coupled to the operator workstation 40 may be utilized to observe the reconstructed images and to control imaging. Additionally, the images may also be printed by a printer 44 which may be coupled to the operator workstation 40.

Further, the processing component 30 and operator workstation 40 may be coupled to other output devices, which may include standard or special purpose computer monitors and associated processing circuitry. One or more operator workstations 40 may be further linked in the system for outputting system parameters, requesting examinations, viewing images, and so forth. In general, displays, printers, workstations, and similar devices supplied within the system may be local to the data acquisition components, or may be remote from these components, such as elsewhere within an institution or hospital, or in an entirely different location, linked to the image acquisition system via one or more configurable networks, such as the Internet, virtual private networks, and so forth.

It should be further noted that the operator workstation 40 may also be coupled to a picture archiving and communications system (PACS) 46. PACS 46 may in turn be coupled to a remote client 48, radiology department information system (RIS), hospital information system (HIS) or to an internal or external network, so that others at different locations may gain access to the raw or processed image data.

While the preceding discussion has treated the various exemplary components of the imaging system 10 separately, these various components may be provided within a common platform or in interconnected platforms. For example, the processing component 30, memory 38, and operator workstation 40 may be provided collectively as a general or special purpose computer or workstation configured to operate in accordance with the aspects of the present disclosure. In such embodiments, the general or special purpose computer may be provided as a separate component with respect to the data acquisition components of the system 10 or may be provided in a common platform with such components. Likewise, the system controller 24 may be provided as part of such a computer or workstation or as part of a separate system dedicated to image acquisition.

The system of FIG. 1 may be utilized to acquire X-ray projection data for a variety of views about a region of interest of a patient to reconstruct images of the imaged region using the projection data. In particular, projection data acquired by a system such as the imaging system 10 may be iteratively reconstructed, or otherwise processed post-reconstruction, using a “negative” dictionary learning-based iterative reconstruction as discussed herein.

In conventional dictionary learning approaches, image reconstruction is performed using a database (i.e., a “dictionary”) of representative image patches (i.e., atoms”). The reconstruction process is encouraged to generate images that have some similarities to the patterns/patches in the database or that look like a superposition of patterns from the dictionary. That is, the image reconstruction process uses the dictionary images as desirable structures or targets to be emphasized and reinforced in the iterative image reconstruction process.

Conversely, the present “negative” dictionary approach discussed herein includes undesired image patches or patterns. Examples of undesired features or structures that may be represented in a negative dictionary include, but are not limited to features or structures associated with poor image quality, including noise and/or artifacts. As a consequence, the negative dictionary, unlike a conventional dictionary, is used in the iterative reconstruction process to actively suppress or deemphasize (e.g., subtract, negatively weight, and so forth) structures or patterns present in the negative dictionary, this deemphasizes or removes such structures in the final image. For example, patterns found in the negative dictionary, in one implementation, may be penalized or negatively weighted in the reconstruction process. In contrast, this is in contrast to other approaches, in which bad or undesired image patches identified in a dictionary learning approach merely have a zero-weight applied to (i.e., not emphasizing or inactivating) the respective pattern given pattern while actively emphasizing the good or desired image patches.

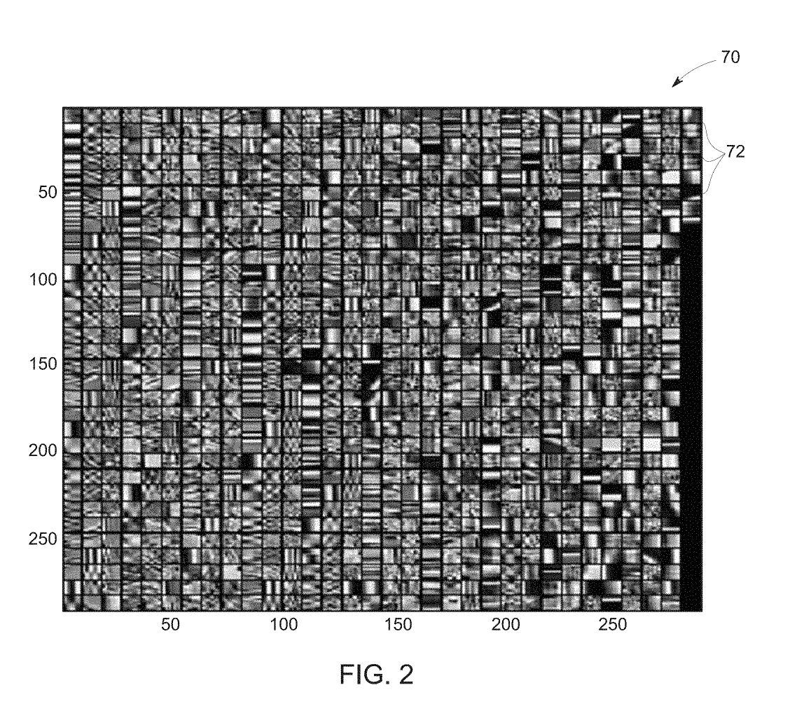

As used herein, a dictionary is a collection of “atoms”, where each atom is a learned image patch, as discussed in greater detail below. An example of a dictionary 70 is shown in FIG. 2. A dictionary 70 consists of a collection of atoms 72. Each atom 72 is a column in the dictionary 70 and image patches used to learn such a dictionary 70 can be represented by the linear combination of such atoms 72, with a small number of atoms having non-zero coefficients. An image patch in such a context is a relatively small image such as, for example, an 8×8 image. In order to learn the dictionary 70 (as discussed in greater detail below), image patches can be sampled from the original patient/object images or from other sources, such as reference images.

In dictionary learning approaches, including negative dictionary learning approaches, local image blocks from an acquired image are described by a linear sum of learned atoms 72 (image blocks containing or depicting basic structural elements or features). The coefficients of this linear expression are referred to as sparse coefficients (αₛ), since only a sparse number of them are non-zero. Conceptually, the atoms 72 constitute the words or basic patterns of the dictionary 70 to which regions in an iteratively processed image are compared or decomposed into as part of the regularization process. In this sense, dictionary learning assumes sparse representation (as denoted by sparse representation coefficient αₛ) of signals (i.e., images). Using a dictionary 70 (denoted as D herein) of constituent image features or components, signals are described by sparse linear combinations of the dictionary elements (i.e., atoms 72), which in the case of negative dictionary learning may be undesirable structures or image features, such as features that may be actively suppressed or deemphasized (e.g., negatively weighted or subtracted) during processing, in contrast to merely applying a zero-weighting to such regions.

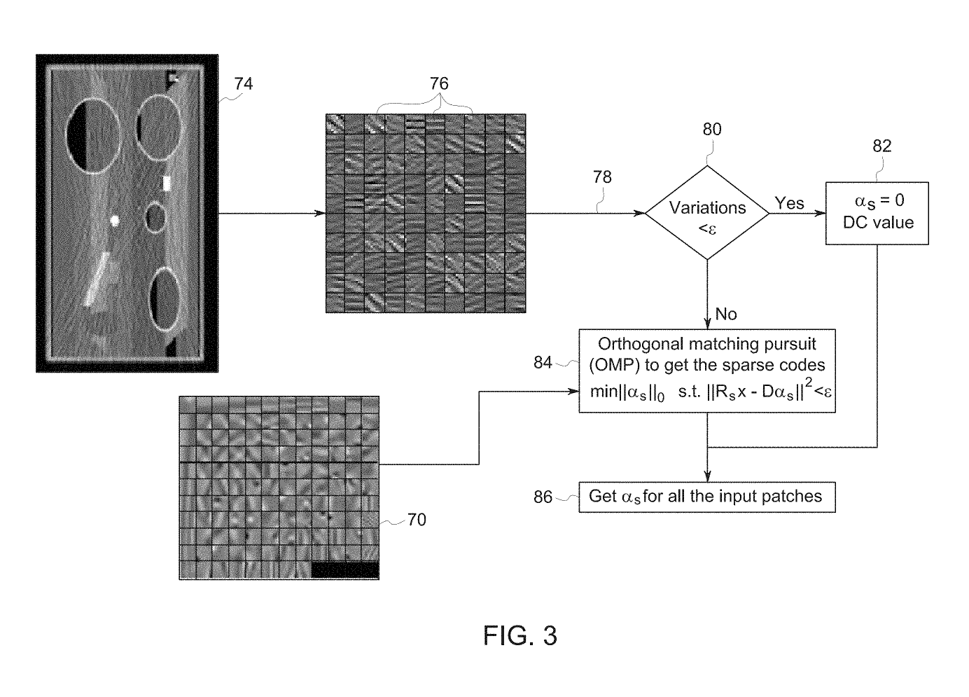

By way of example, in operation dictionary learning may attempt to minimize the number of non-zero sparse representation coefficients and/or minimize the fitting error between extracted local patches of a sampled image and the corresponding negative dictionary representations so as to identify and suppress the occurrence of those image patches found within the negative dictionary. That is, in a dictionary learning implementation, the algorithms may attempt to minimize the number of unmatched region and to minimize the fitting error of modeled patches. A high level example of sparse coding by which sparse representation coefficients α may be estimated for an input image (x) 74 using a dictionary (D) 70 is shown in FIG. 3. In this example, local image patches Rₛ 76 (e.g., non-overlapping image patches) are extracted and the mean value (DC) is extracted (step 78) from each patch 76. A determination (decision block 80) is then made for each patch 76 whether the variation is less than ε or greater than or equal to E. If less than ε, the sparse coefficient αₛ is 0 (step 82) (i.e., the variation is encompassed by the DC value). If greater or equal than ε, orthogonal matching pursuit (OMP) is used (step 84) to obtain the sparse coefficients αₛ in accordance with:

min∥αₛ∥₀ (1)

subject to:

∥Rₛx−Dαₛ∥²<ε (2)

where αₛ is the sparse representation coefficient, Rₛ is a local image patch extracted at pixel s, D is a dictionary, x is the input image, and ε is target error. The sparse representation coefficients αₛ are determined (step 86) to all input patches 76.

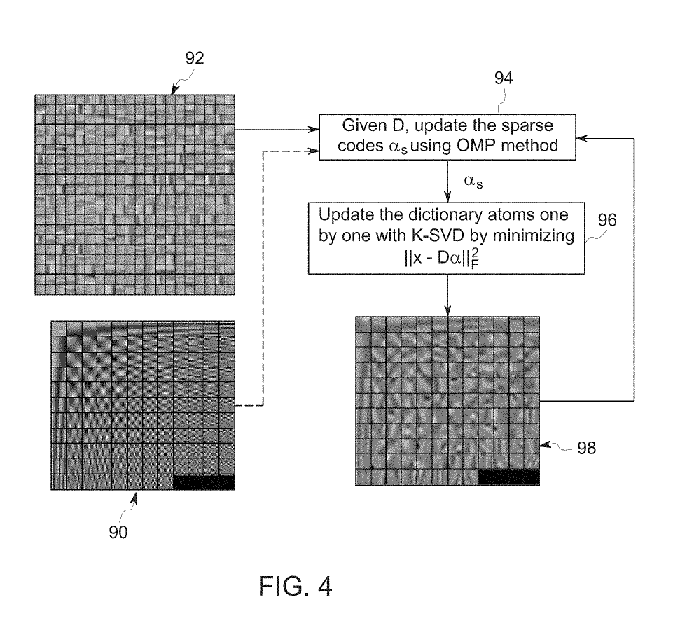

The sparse representation coefficients αₛ determined as shown in FIG. 3 may be used as part of a dictionary training process, in this instance, training a negative dictionary, as shown in FIG. 4, which may be used in the negative dictionary based reconstructions discussed herein. As shown in FIG. 4, a dictionary D 70 as used herein may be trained (such as using the K-SVD algorithm) as part of an initial and/or ongoing part of the dictionary learning process. This training stage is based on assumption that all the patches can be linear represented by the column (atom) in the dictionary with only a sparse number of atoms having a non-zero coefficient. This is shown in equation (3):

$${min}_{D , α} {\sum }_{s} {‖ {R}_{s} μ - D {α}_{s} ‖}_{F}^{2} + {\sum }_{s} λ {‖ {α}_{s} ‖}_{0} \qquad ( 3 )$$

where parameter λ controls the sparsity of the learned coefficients αₛ. In one implementation, the K-SVD algorithm may be used to learn the dictionary and calculate the sparse coefficients.

In the depicted example of FIG. 4, the dictionary training process involves providing both an initial dictionary (Discrete Cosine Transform (DCT)) 90 and a set of collected image patches 92 (e.g., 8×8 image patches) for training from which the mean value (DC) has been extracted. Based on the image patches 92 and initial dictionary 90, the sparse codes αₛ are updated, such as using the OMP method described above, at step 94. Based on the updated αₛ, the initial dictionary atoms may be updated (step 96) one by one, such as by minimizing:

∥x−Dα∥_{F}² (4)

to generate the updated dictionary 98. In present implementations, the dictionary training process is used to train a negative dictionary having instances of atoms or image patches which are to be deemphasized or removed during iterative image reconstruction. Keeping in mind the above, the described sparse coding and dictionary learning approaches may be used with the present approaches as part of both developing and/or updating the negative dictionaries employed.

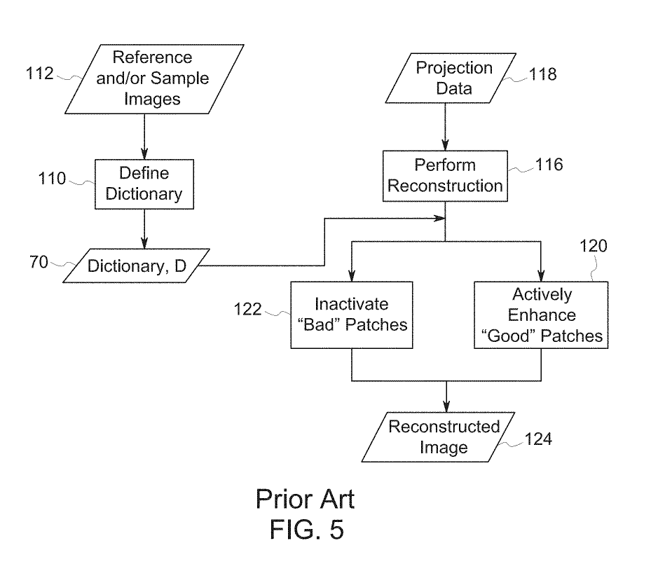

With the preceding in mind, certain implementations of present approach utilize a negative dictionary-based algorithm in an MBIR context (such as in a low dose CT image reconstruction context) to reduce or remove undesired features from the reconstructed images. This is in contrast to conventional approaches where such regions are merely given a zero-weight. For example, FIG. 5 depicts a simplified process flow for a prior technique by which “bad” image patches are not actively suppressed or removed. In this example, a dictionary 70 is defined (block 110) based on one or more reference images or from sample images 112 derived from a current examination. In this example, for simplicity, the dictionary 70 may be considered to have image patches that are to be emphasized (i.e., “good” image patches) and image patches that are to be inactivated or not otherwise actively emphasized in the reconstruction (i.e., “bad” image patches).

In the conventional approach, the dictionary 70 is used during the reconstruction (block 116) of projection data 118. In particular, regions corresponding to the good image patches are actively enhanced (block 120) (e.g., given a positive weighting) in the reconstruction process while regions corresponding to the bad image patches are inactive (block 122) (i.e., given a zero weight or coefficient) in the reconstruction process. Based on this differential weighting employed in the reconstruction process, a reconstructed image 124 is generated.

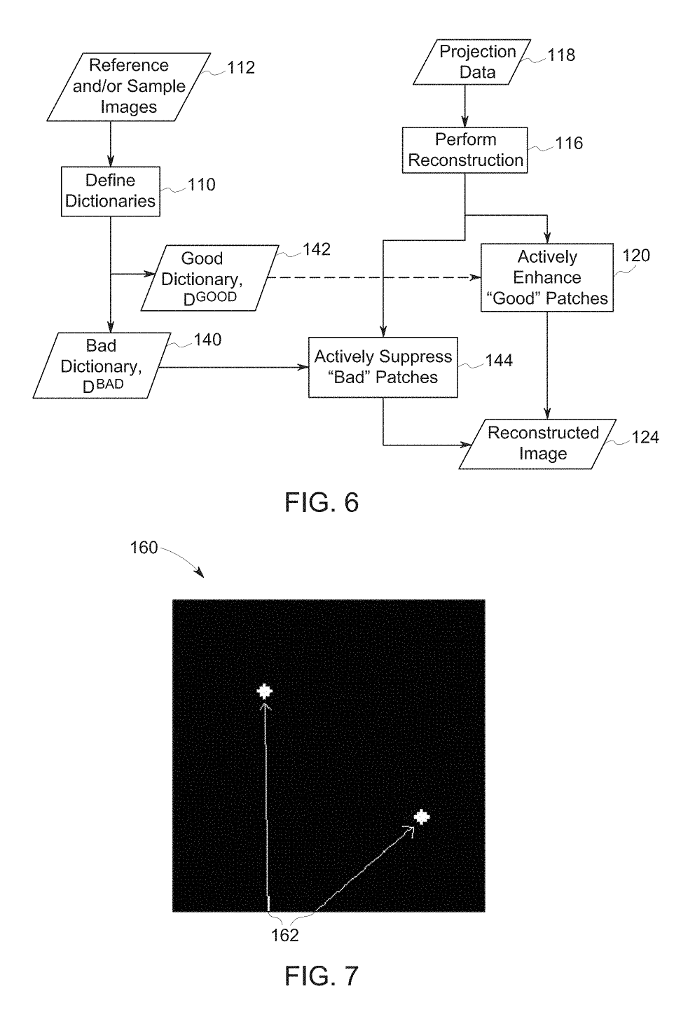

The present approach, as described herein and shown at a high-level in the process flow diagram of FIG. 6, covers the construction and use of both a negative (i.e., “bad”) dictionary 140 (i.e., D^{BAD}) in addition to a positive, i.e., “good”, dictionary 142 (i.e., D^{GOOD}) of desirable structural image features (in practice both the negative and positive dictionary may be combined as a single dictionary) and the active suppression of those atoms found in the negative dictionary. For example, as shown, both the negative dictionary 140 and positive dictionary 142 may be defined (block 110) based on one or more reference images or from sample images 112 derived from a current examination.

In the present approaches, described in greater detail below, both the positive dictionary 142 and the negative dictionary 140 are used during the reconstruction (block 116) of projection data 118. Regions corresponding to the good image patches found in the positive dictionary 142 are actively enhanced (block 120) (e.g., given a positive weighting) in the reconstruction process. Conversely, and unlike the conventional approach described above, the regions corresponding to the bad image patches found in negative dictionary 140 are actively suppressed (e.g., given a negative weight and/or otherwise processed to remove or subtract the features) (block 144) in the reconstruction process. Based on this active suppression of negative features and active enhancement of positive features during the reconstruction process, a reconstructed image 124 is generated. These approaches also relate to the use of the negative dictionary 140 and positive dictionary 142 in the context of a cost function or iterative algorithm used in image reconstruction or image processing in general.

With respect to the negative dictionary 140, a variety of detrimental or undesired image features or patterns may be represented. Examples of image features that may be represented include, but are not limited to image or image components associated with: artifacts or streak patterns; noise patterns; impulses (i.e., isolated high or low values); ring artifacts; blurred boundaries; and other two-dimensional, three-dimensional, two-dimensional (in differing directions), or four-dimensional image patterns.

The negative dictionary 140 may be constructed using a variety of methods. For example, in one implementation, which may be construed as an image processing implementation, artifacts and noise are extracted from existing noisy images by image processing techniques (such as via steerable-filtering) and machine learning. By way of example, in one implementation a given noisy image is broken down into multiple component images, with component corresponding to a specific kind of artifact (e.g., streaks, shading, and so forth) or noise. The component images generated in this manner can very well be used to learn D^{BAD} 140.

In a further implementation, which may be construed as a simulations based approach, different textures of noise and types of streaks may be simulated based on CT simulations for various geometries and scan protocols. The negative dictionary D^{BAD} 140 can then be generated from the resulting simulated noisy images.

In another implementation, which may be construed as a noise insertion approach, realistic noise or streaks can be added to existing high-quality data, either measurements or images (though some form of reconstruction should be performed if this is done on the measurements). The noise inserted images may then be subtracted from the originals and the resulting difference images used to learn D^{BAD} 140.

Though these possible approaches of learning the negative dictionary are described above in isolation, it should be appreciated that these approaches may be combined to provide hybrid or combined approaches for learning D^{BAD} 140.

With regard to the positive (i.e., “good”) dictionary D^{GOOD} 142, this dictionary may be learned directly from existing high quality images or by using images from which the artifact and/or noise components are first subtracted and the resulting difference images used to learn D^{GOOD} 142. Other conventional dictionary learning may also be used to generate the positive dictionary 142 with the understanding that the atoms of the positive dictionary constitute image structures or features that are generally desired (and, hence, emphasized or reinforced during reconstruction iterations) in the final reconstructed image 124.

As discussed above, the present methodology incorporates negative dictionary 140 learning as part of an iterative reconstruction term. By way of example, learning from a negative dictionary 140 can be implemented by performing an ad hoc update step that guides the iterative image reconstruction away (i.e., actively suppresses or negatively weights) from the patterns represented in the negative dictionary 140 (i.e., the “bad” patterns) for which similarity is observed in the reconstructed image. In such an implementation, dictionary learning updates can be performed simultaneous with the reconstruction step, in alternation with the reconstruction step, or after reconstruction as a post-processing step.

By way of example, one such ad hoc update step incorporating a negative dictionary may be characterized by:

μ+=c₁·∇C₁ (5)

followed by:

μ+=c₂·∇C₂ (6)

with:

$${C}_{1} = {\sum }_{i} {{w}_{i} ( {p}_{i} - {\sum }_{j} {l}_{ij} {μ}_{j} )}^{2} + {\sum }_{p} {‖ {μ}_{p} - {D}^{GOOD} {α}_{p} ‖}_{2}^{2} + {\sum }_{p} {‖ {α}_{p} ‖}_{1} \qquad ( 7 )$$

and:

$${C}_{2} = {\sum }_{p} {‖ {μ}_{p} - {D}^{BAD} {β}_{p} ‖}_{2}^{2} + {\sum }_{p} {‖ {β}_{p} ‖}_{1} \qquad ( 8 )$$

where c₁ and c₂ correspond to cost functions for different directions, wᵢ are the statistical weights, index i is the sinogram index, pᵢ are the measured projection data, Iᵢⱼ are the system model (e.g. projector-backprojector) coefficients, index j is the voxel index, index p is the image patch index, μₚ is the vector of image voxel values corresponding to patch p, D^{GOOD} and D^{BAD} are the good and bad dictionaries respectively, αₚ and βₚ are the vectors of coefficients with sparse constraints to be applied to the good and bad dictionary patches respectively.

In a different implementation, the negative dictionary 140 can be employed as part of a data fit term in the iterative reconstruction process. In such an implementation, the reconstructed image may be split, using the negative dictionary 140, into an artifact term and an image term. That is, the negative dictionary 140 can be used as part of the data fit aspect of the iterative reconstruction objective function to identify those aspect of the image that are likely artifact or other undesired signal, which can be split out as an artifact component, which the good data signal is then not fitted to.

By way of example, a penalized weighted least squares cost function incorporating a good and a bad dictionary in the data fit term may be characterized by:

$$C = {\sum }_{i} {{w}_{i} ( {p}_{i} - {\sum }_{j} {l}_{ij} ( {μ}_{j}^{GOOD} + {μ}_{j}^{BAD} ) )}^{2} + {\sum }_{p} {‖ {μ}_{p}^{GOOD} - {α}_{p} {D}^{GOOD} ‖}_{2}^{2} + {\sum }_{p} {‖ {α}_{p} ‖}_{1} + {\sum }_{p} {‖ {μ}_{p}^{BAD} - {β}_{p} {D}^{BAD} ‖}_{2}^{2} + {\sum }_{p} {‖ {β}_{p} ‖}_{1} \qquad ( 9 )$$

where μⱼ^{GOOD} are μⱼ^{BAD} the desired reconstructed image 124 and the artifact image respectively. Alternatively, another example of a penalized weighted least squares cost function incorporating a good and a bad dictionary in the data fit term is shown by:

$$C = {\sum }_{i} {{w}_{i} ( {p}_{i} - {\sum }_{j} {l}_{ij} ( {μ}_{j}^{GOOD} + {\sum }_{p} {β}_{p} {D}^{BAD} ) )}^{2} + {\sum }_{p} {‖ {μ}_{p}^{GOOD} - {α}_{p} {D}^{GOOD} ‖}_{2}^{2} + {\sum }_{p} {‖ {α}_{p} ‖}_{1} + {\sum }_{p} {‖ {β}_{p} ‖}_{1} \qquad ( 10 )$$

In a further implementation, the negative dictionary 140 may be employed as a term in a cost function used in the image reconstruction optimization. In such an approach, the term based on the negative dictionary 140 may have an opposite sign (e.g., a negative (−) sign) relative to the sign of traditional prior terms, where the represented image features are desired and reinforced during reconstruction. In this manner, the features represented in the negative dictionary 140 may be de-emphasized or reduced in the image reconstruction process.

By way of example, a penalized weighted least squares cost function incorporating a term with an opposite sign for the bad dictionary cost may be characterized by:

$$\begin{matrix}C 1 = {\sum }_{p} {‖ {μ}_{p} - {α}_{p} {D}^{GOOD} ‖}_{2}^{2} + {\sum }_{p} {‖ {α}_{p} ‖}_{1} + {\sum }_{p} {‖ {μ}_{p} - {β}_{p} {D}^{BAD} ‖}_{2}^{2} + {\sum }_{p} {‖ {β}_{p} ‖}_{1} & ( 11 ) \\ C 2 = {\sum }_{i} {{w}_{i} ( {p}_{i} - {\sum }_{j} {l}_{ij} {μ}_{j} )}^{2} + {\sum }_{p} {‖ {μ}_{p} - {α}_{p} {D}^{GOOD} ‖}_{2}^{2} = {\sum }_{p} {‖ {μ}_{p} - {β}_{p} {D}^{BAD} ‖}_{2}^{2} & ( 12 )\end{matrix}$$

where C1 is minimized to determine α and β and C2 is minimized to update the image estimate μ.

Alternatively, another example of a cost function implementation is shown by:

$$C = {\sum }_{i} {{w}_{i} ( {p}_{i} - {\sum }_{j} {l}_{ij} {μ}_{j} )}^{2} + {\sum }_{p} {‖ {μ}_{p} - {α}_{p} {D}^{GOOD} ‖}_{2}^{2} + {\sum }_{p} {‖ {α}_{p} ‖}_{1} + {\sum }_{p} {‖ {μ}_{p} - {α}_{p} {D}^{GOOD} - {β}_{p} {D}^{BAD} ‖}_{2}^{2} + {\sum }_{p} {‖ {β}_{p} ‖}_{1} \qquad ( 13 )$$

where, in a first step μ, α, and β are updated so as to minimize cost function C. In a subsequent step, μ is updated based on bad dictionary similarity. For example, μ may be updated such that:

μ:=μ−βₚD^{BAD} (14)

Here the term ∥μₚ−αₚD^{GOOD}−βₚD^{BAD}∥₂² means that any patch can be well represented by using the atoms from positive and negative dictionaries D^{GOOD} 142 and D^{BAD} 140. The term ∥μₚ−αₚD^{GOOD}∥₂² means that the patch can also be represented by using the positive dictionary 142. This term helps ensure that the good dictionary 142 plays an important role in the reconstruction.

With the preceding in mind, and turning to FIGS. 7-9, an example of a negative dictionary learning approach used to remove noise and artifacts from an image is provided. In this example, FIG. 7 depicts an initial image 160 generated using round phantoms 162 of known size, composition, and placement. In the absence of other factors, the phantoms generate a clean initial image with known properties for use in subsequent operations.

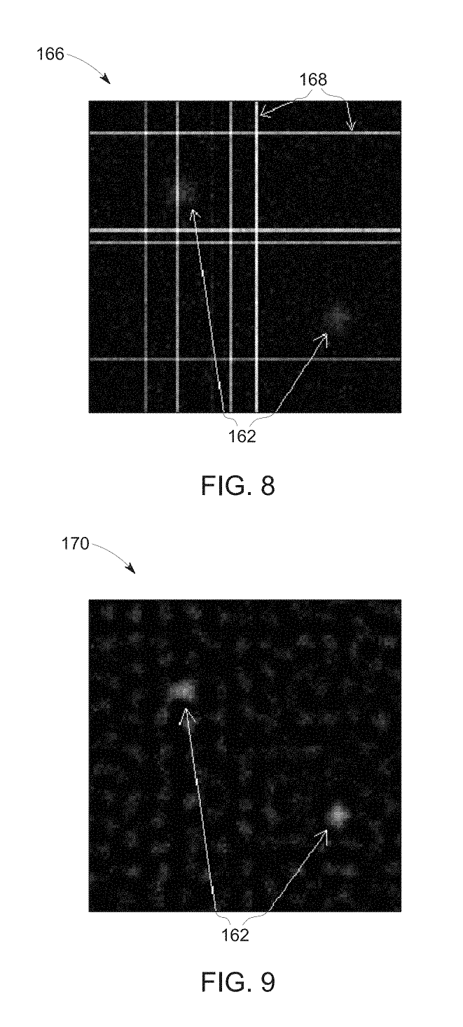

Turning to FIG. 8, in this study, noise and blur were added to the initial image 160 to generate a noisy image 166. In particular, the initial image 160 was processed to add a Gaussian blur (based around a 3 pixel neighborhood), simulated pixel noise, and horizontal and vertical streaking 168, as shown in noisy image 166.

The noisy image 166 was then processed using an iterative deblurring approach incorporating a negative dictionary 140 and active suppression (e.g., negative weighting) of image patches found in the negative dictionary 140, which included image patches corresponding to vertical and horizontal streak artifacts 168. As shown in FIG. 9, the resulting processed image 170 no longer has the streak artifacts 168, which have been actively suppressed (i.e., removed) based on the image patches defined in the negative dictionary 140. Consequently, artifact removal and/or suppression using the present approaches results in image improvements including, but not limited to, artifact removal and/or suppression.

Technical effects of the invention include the use of a database (i.e., a dictionary) of image patterns to be avoided or de-emphasized during an image reconstruction process, such as an iterative image reconstruction process. Such a dictionary may be characterized as a negative or “bad” dictionary. The negative dictionary may be used to constrain an image reconstruction process to avoid or minimize the presence of the patterns present in the negative dictionary. Technical effects further include improvements in image quality (leading to improved diagnostic value) and/or radiation dose reduction.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

1. A method of constructing a negative dictionary, comprising:
accessing one or more images;
sampling a plurality of image patches from the one or more images;
identifying a subset of the image patches corresponding to detrimental image features or patterns; and
populating the negative dictionary using the subset of image patches.

2. The method of claim 1, wherein the detrimental image features or patterns correspond to one or more of artifact patterns, streak patterns, noise patterns, ring artifacts, blurred boundaries, or impulses.

3. The method of claim 1, wherein:
accessing the one or more images comprises accessing one or more noisy images; and
sampling the plurality of images and identifying the subset of image patches comprises extracting one or both of artifact patterns or noise patterns from the noisy images.

4. The method of claim 3, wherein extracting one or both of artifact patterns or noise patterns from the noisy images comprises employing one or both of steerable filtering or machine learning to extract the artifact patterns or noise patterns.

5. The method of claim 3, wherein extracting one or both of artifact patterns or noise patterns from the noisy images comprises breaking one or more of the noisy images into component images, each corresponding to a type or artifact pattern or noise pattern.

6. The method of claim 1, further comprising:
simulating different noise patterns and artifact patterns;
generating the one or more images to include the noise patterns and artifact patterns.

7. The method of claim 6, wherein the different noise and artifact patterns are simulated based on different scan geometries and scan protocols.

8. The method of claim 1, further comprising:
adding one or both of noise patterns or artifact patterns to one or more initial images to generate noise-added images or to one or more initial measurements that are reconstructed to generate the one or more noise-added images;
using the noise-added images in an image subtraction process to generate the one or more images.

9. A method for reconstructing an image, comprising:
acquiring a set of measurements for an imaged volume;
performing a reconstruction of the set of measurements using a negative dictionary, wherein the negative dictionary comprises image patches corresponding to detrimental image features or patterns that are actively suppressed or negatively weighted during the reconstruction; and
generating a reconstructed image as an output of the reconstruction.

10. The method of claim 9, wherein the detrimental image features or patterns correspond to one or more of artifact patterns, streak patterns, noise patterns, ring artifacts, blurred boundaries, or impulses.

11. The method of claim 9, wherein the reconstruction comprises a model-based iterative reconstruction.

12. The method of claim 11, wherein the reconstruction comprises an update step that guides the model-based iterative reconstruction away from the detrimental image features or patterns represented in the image patches present in the negative dictionary.

13. The method of claim 11, wherein the reconstruction uses the negative dictionary as part of a data fit term of model-based iterative reconstruction.

14. The method of claim 13, wherein the reconstruction splits a reconstructed image into an artifact term and an image term based on the use of negative dictionary in the data fit term.

15. The method of claim 9, wherein the reconstruction uses the negative dictionary as a term in a cost function.

16. The method of claim 15, wherein the term based on the negative dictionary has an opposite sign to a term based on a conventional prior term.

17. An image processing system, comprising:
a memory storing one or more routines; and
a processing component configured to access previously or concurrently acquired measurement data and to execute the one or more routines stored in the memory, wherein the one or more routines, when executed by the processing component:
perform a reconstruction of a set of measurements using a negative dictionary, wherein the negative dictionary comprises image patches corresponding to detrimental image features or patterns that are actively suppressed or negatively weighted during the reconstruction; and
generate a reconstructed image as an output of the reconstruction.

18. The image processing system of claim 17, wherein the reconstruction comprises an update step of a model-based iterative reconstruction that guides the model-based iterative reconstruction away from the detrimental image features or patterns represented in the image patches present in the negative dictionary.

19. The image processing system of claim 17, wherein the reconstruction uses the negative dictionary as part of a data fit term of a model-based iterative reconstruction.

20. The image processing system of claim 17, wherein the reconstruction uses the negative dictionary as a term in a cost function.
